(19) United States
(12) Patent Application Publication
(10) Pub. No.: US 2006/0109108 A1
(43) Pub. Date: May 25, 2006

(54) System and method for locating an object

(76) Inventor: Stephen Powders, Fort Worth, TX (US)

Correspondence Address: JAMES RAY & ASSOCIATES, 2640 PITCAIRN ROAD, MONROEVILLE, PA, 15146, US

(21) Appl. No.: 11/267,684

(22) Filed: Nov. 4, 2005

Related U.S. Application Data
(60) Provisional application No. 60/629,880, filed on Nov. 19, 2004.

(51) Int. Cl. G08B 1/08

(52) U.S. Cl. 340/539.13

(57) ABSTRACT

A system for locating an object includes a master control member and at least one slave member, each having a housing of a predetermined shape and a predetermined size, a transmitter for transmitting a radio frequency signal, a receiver for receiving a feedback signal and a power source. The master control member and the slave member are capable of emitting light and sound in response to receiving such first and second signals. The slave member may be adapted for intermittently transmitting such first signal and providing an advance warning when the object is in a range of operation of such system.

### CROSS-REFERENCE TO RELATED APPLICATIONS

This application is related to and claim priory from U.S. Provisional Patent Application Ser. No. 60/629,880 filed Nov. 19, 2004.

### FIELD OF THE INVENTION

The present invention relates, in general, to a system and method for locating misplaced and/or obstructed view objects and, more particularly, this invention relates to a system and method for locating articles of luggage.

### BACKGROUND OF THE INVENTION

Devices for locating an object and, particularly a luggage article at the airport, are generally well known in the art. U.S. Pat. No. 6,342,836 to Zimmerman, U.S. Pat. No. 6,147,602 to Bender, U.S. Pat. No. 6,075,443 to Schepps et al and U.S. Pub. No. 2004/0113776 to Goggin disclose various types of radio frequency transmitters operable by an owner of the luggage article and receivers attached to the luggage article and capable of emitting both light and sound.

One disadvantage of the presently available devices for locating a luggage article is that the owner of such luggage does not receive any advance notification that the luggage has arrived to a claim area and will be available for retrieval. Accordingly, there is a level of increased anxiety associated with anticipation of the luggage arrival. Furthermore, the owner is reluctant to leave the claim area and attend to other personal matters for concern of missing the luggage arrival.

Another disadvantage of the presently available devices for locating luggage is that the owner must manually operate the transmitter in order to activate the receiver and enable the receiver to emit light or sound.

### SUMMARY OF THE INVENTION

The present invention provides a system for locating an object. Such system includes a master control member and at least one slave member. Each of the master control member and the at least one slave member has a housing of a predetermined shape and a predetermined size, a transmitter for transmitting a radio frequency signal, a receiver for receiving a feedback signal and a power source. The master control member and the at least one slave member are capable of emitting light and sound in response to receiving such first and second signals.

According to one aspect of the invention the master control member is activated to transmit the first signal which is received by the at least one slave member and triggers transmitting of the second signal to the master control member and activation of the second annunciation signal at the at least one slave member. The receipt of the second signal at the master control member triggers activation of the first annunciation signal warning the owner of the object that such object is within an operable range of the system. The object is than located by observing the second annunciation signal at the at least one slave member.

According to another embodiment of the invention, the slave member is adapted for intermittently transmitting the first signal which is received at the master control member when the object enters the operable range of the system and triggers activation of the first annunciation signal at the master control member. The second signal is than transmitted to the slave member activating emission of the second annunciation signal at the slave member for locating such object.

### OBJECTS OF THE INVENTION

It is, therefore, one of the primary objects of the present invention to provide a system and method for locating an object.

Another object of the present invention is to provide a system and method for locating an object which enables advance notification of the object's presence within the operable range.

A further object of the present invention is to provide a system for locating an object which enables both visual and audible identification of the object.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a front elevation view of the present invention attached to an article of luggage;

FIG. 2 is a plan view of a master control member of the present invention;

FIG. 3 is a plan view of a slave member of the present invention;

FIG. 4 is a schematic representation of the master control member of FIG. 2;

FIG. 5 is a schematic representation of the slave member of FIG. 3; and

FIG. 6 is a plan view of a charging unit of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

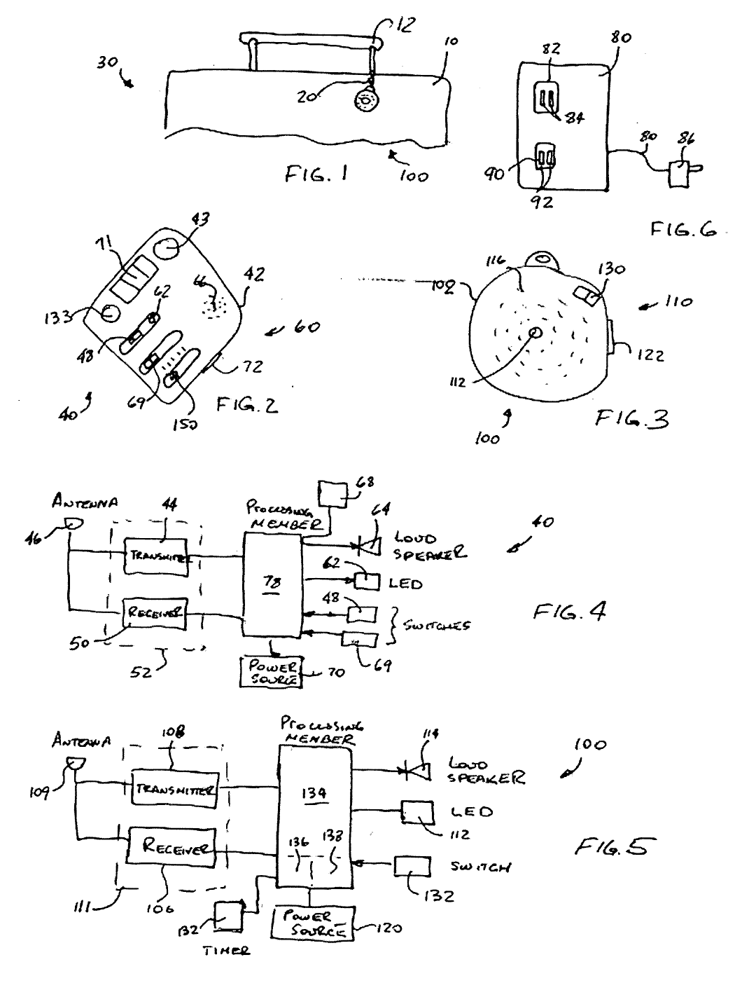

Reference is now made, to FIGS. 1-6, wherein there is shown a system, generally designated 30, for locating an object 10. Such system 30 comprises a master control member, generally designated 40, including a housing 42 having each of a predetermined shape and a predetermined size. The housing 42 may include an aperture 43 or hook (not shown) for attaching such master control member 40 to a well known key ring 20. There is a means 44 disposed within the housing 42 for transmitting a first signal. Such first signal may be one of radio frequency, sound, infrared, sonic, and ultrasonic. In the presently preferred embodiment of the invention, such first signal is a radio frequency signal characterized by a predetermined frequency band. Accordingly, means 44 is a radio frequency transmitter means 44 and the master control member 40 further includes an antenna means 46 engageable with the housing 42 and coupled to such transmitter means 44 for wirelessly transmitting such first signal. To initiate transmittal of such first signal, the master control member 40 is provided with an activation means 48 accessible and operable from an outer surface of the housing 42 and which is coupled to the processing member 78 which is provided to control operation of the master control member 40.

Preferably, the activation means 48 is at least one switch means 48 movable between a first position to activate such transmitter means 44 and such master control member 40 and a second position to deactivate such transmitter means 44 and such master control member 40.

Means 50, disposed within the housing 42, is provided for receiving a second signal. Such second signal may be one of radio frequency, sound, infrared, sonic, and ultrasonic and preferably the second signal is such radio frequency signal characterized by a frequency band which is identical to the frequency band of the first signal. Accordingly, the receiving means 50 is a radio frequency receiver 50. Alternatively, the transmitter 44 and the receiver 50 may be combined to form a transceiver 52.

The master control member 40 is further provided with means, generally designated 60, for emitting a first annunciation signal responsive to a receipt of the second signal by such receiving means 50. Such first annunciation signal may be one of a visual signal, audible signal and preferably a combination thereof.

To provide the visual signal, the means 60 includes a light source 62, such as LED, visible through the outer surface of the housing 42. To provide the audible signal, the means 60 includes a speaker 64 mounted behind a port 66 which is disposed within the outer surface of the housing 42. Such means 60 may further include a vibration generator 68 for generating a mechanical vibration. A second switch 69 may be provided for switching operation between a speaker 64 and vibration generator 68.

Additionally, the master control member 40 is provided with a power source 70 which is disposed within the housing 42. Preferably, the power source 70 is a battery which may be a rechargeable type. Furthermore, a pair of electrical contacts 72 are disposed on the housing 42 for recharging such rechargeable battery 70.

Accordingly, a recharging device 80, containing a cradle 82 for at least partially receiving the housing 42 and electrical contacts 84 disposed within such cradle 82 and aligned with electrical contacts 72 on the housing 42, may be provided for charging the rechargeable battery 70 of the master control member 40. A power supply adapter 86 is coupled to the recharging device 80 with a power cable 88 for providing operating power to the recharging device 80 and for providing a source of current for recharging the battery 70. Alternatively, such power source 70 may be a solar collector 71.

The system 30 further includes a slave member, generally designated 100, best shown in FIGS. 3 and 5, which includes a housing 102 having each of a predetermined shape and a predetermined size and means 104 engageable with the housing 102 for one of removable and rigidly attaching it to a predetermined portion of such object 10. Such means 104 may be a hook 104 or an aperture for attaching the slave member 100 to a handle 12 of the object 10, being an article of luggage, with such key ring or a chain 20. Alternatively, as is well known in the art, the slave member 100 may be incorporated directly into a portion of the luggage.

Means 106 is disposed within the housing 102 for receiving the first signal and means 108 is provided for transmitting the second signal upon receiving the first signal. Such receiving means 106 and transmitting means 108 are connected to an antenna means 109. Alternatively, the receiving means 106 and transmitting means 108 may be combined into a transceiver 111. There is means 110 disposed within the housing 104 for emitting a second annunciation signal responsive to receipt of the first signal. Such second annunciation signal may be one of a visual signal, audible signal and a combination thereof. To provide the visual signal, the means 110 includes a light source 112, such as an LED, visible through the outer surface of the housing 102. To provide the audible signal, means 110 includes a speaker 114 mounted behind a port 116 which is disposed within the outer surface of the housing 102.

The slave member 100 is provided with a power source 120 disposed within the housing 102. When such power source 120 is a rechargeable battery 120, the slave member 100 may be provided with an independent recharging device (not shown) but preferably, the recharging device 80 is adapted with at least one second cradle 90 having electrical contacts 92 for alignment with electrical contacts 122 disposed on the housing 102 for recharging the battery 120 of the slave member 100.

Alternatively, such power source 120 may be a solar collector (not shown).

The slave member 100 may be further provided with a switch means 130 accessible from the outer surface of the housing 102 for selectively initiating and discontinuing operation of the slave member 100. Selective operation of such slave member 100 is advantageous in conserving the life of the power source 120. Furthermore, the master control member 40 may be provided with means 133 for deactivating the annunciating means 60.

In operation, according to one embodiment of the invention, when the owner of such master control member 40 is within the operative range of such system 30, such owner operates the activation means 48 to enable transmitter means 44 to transmit the first signal to the slave member 100 which is received by the receiver means 106. In response to the receipt of the first signal, the transmitter means 108 of the slave member 100 transmits the second signal and means 110 emits a second annunciation signal. When the second signal is received by the receiver means 50 of the master control member 40 it triggers means 60 to emit the first annunciation signal warning the owner that the object is disposed within the operable range.

The master control member 40 may be equipped to transmit such first signal at a predetermined interval after operation of the activation means 48 until the second signal is received by the receiver means 50 and the first annunciation signal is emitted.

Alternatively, the owner may intermittently operate such activation means 48 until the second signal is received by the receiver means 50 and such first annunciation signal is emitted. The owner then locates the object by detecting such second annunciation signal emitted from the slave member 100 and operates the switch means 130 or the switch means 133 to deactivate operation of the slave member 100. Alternatively, the operation of the slave member 100 is discontinued by a timer means 132 after a predetermined time period upon receipt of the first signal.

According to another embodiment of the invention, the slave member 100 may be equipped for intermittently transmitting the first signal to the master control unit 40. Advantageously, such embodiment will enable the luggage owner to attend to other personal matters without concerns for missing arrival of the luggage. When the luggage enters the predetermined range of operation of the system 30, such first signal will trigger emission of the first annunciation signal at the master control member 40. To provide for the intermittent transmitting of the second signal, the processing unit 134 of the slave member 100 is equipped with an internal sleep circuit 136 and wake-up circuit 138. Strength of such first signal transmitted from the slave member 100 may be one of greater than, smaller than and equal to a strength of the second signal transmitted from the master control member 40.

The luggage owner may activate transmittal of the second signal immediately after receiving such first signal or wait for a period of time in order to conserve the power source 120 of the slave member 100.

It will be appreciated that the master control member 40 may be adapted for use with a plurality of slave members 100, each engageable with a respective one of a plurality of objects, whereby the master control member 40 is capable of transmitting a plurality of first signals in one of a selective, sequential and simultaneous manner, each associated with a respective one of the plurality of slave members 100 and is capable of receiving a plurality of second signals each associated with the respective one of the plurality of slave members 100.

The master control member 40 may be equipped with a selector switch 150 for selectively or sequentially operating such plurality of slave members 100, particularly, when such first signal is a uniquely coded signal associated with each of such plurality of slave members 100. Switch means 49 is utilized to simultaneously activate such plurality of slave members 100 adapted for receiving an identical first signal.

Although the present invention has been shown in terms of the system 30 employed for locating a luggage article, it will be apparent to those skilled in the art, that the present invention may be applied to locating other objects, such as a remote control, keys, and the like.

It will be appreciated that the activation means 48 or the switch means 133 of the master control member 40 may be utilized to simply locate the slave member 100.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A system for locating an object, said system comprising:
(a) a master control member including:
(i) a housing having each of a predetermined shape and a predetermined size,
(ii) a transmitting means disposed within said housing for transmitting a first signal,
(iii) an activation means accessible from an outer surface of said housing and connected to said transmitting means for initiating transmittal of said first signal,
(iv) means disposed within said housing for receiving a second signal,
(v) means disposed within said housing for emitting a first annunciation signal in response to receipt of said second signal, and
(vi) a power source disposed within said master; and
(b) a slave member attached to such object, said slave member including:
(i) a housing having each of a predetermined shape and a predetermined size,
(ii) means engageable with said housing for one of removably and rigidly attaching it to a predetermined portion of such object,
(iii) means disposed within said housing for receiving said first signal,
(iv) means disposed within said housing for transmitting said second signal upon receiving said first signal,
(v) means disposed within said housing for emitting a second annunciation signal in response to receipt of said first signal, and
(vi) a power source disposed within said housing.

2. The system, according to claim 1, wherein each of said first signal and said second signal is one of a radio frequency, sound, infrared, sonic, and ultrasonic signal.

3. The system, according to claim 2, wherein each of said first signal and said second signal is said radio frequency signal and each of said master control member and said slave control member includes an antenna means.

4. The system, according to claim 3, wherein said radio frequency signal is characterized by a predetermined frequency band.

5. The system, according to claim 1, wherein said master control member includes an activation means accessible from an outer surface of said housing of said master control member for at least initiating transmittal of said first signal.

6. The system, according to claim 5, wherein said activation means is a switch means.

7. The system, according to claim 1, wherein said power source is one of a battery source and a solar collector.

8. The system, according to claim 7, wherein said battery source is a rechargeable battery.

9. The system, according to claim 8, wherein said system includes a charging unit for recharging said rechargeable battery.

10. The system, according to claim 1, wherein each of said first annunciation signal and said second annunciation signal is one a visual, audible and a combination signal thereof.

11. The system, according to claim 1, wherein each of said first signal and said second signal is coded.

12. The system, according to claim 1, wherein said first annunciation signal emitted by said master control member is a mechanical vibration.

13. The system, according to claim 1, wherein said annunciation means disposed within said master control member is activated when said slave member is disposed within a predetermined distance range.

14. The system, according to claim 1, wherein said slave member includes a switch means accessible from an outer surface of said housing of said slave member for selectively initiating and discontinuing its operation.

15. The system, according to claim 1, wherein said master control member includes means for deactivating emission of said second annunciation signal from said slave member.

16. The system, according to claim 1, wherein said system includes a plurality of said slave members cooperating with said master control member, each engageable with a respective one of a plurality of objects, whereby said master control member is capable of transmitting a plurality of first signals in one of a selective, sequential and simultaneous manner, each associated with a respective one of said plurality of slave members and is capable of receiving a plurality of second signals each associated with said respective one of said plurality of slave members.

17. The system, according to claim 1, wherein a strength of said first signal transmitted from said slave member is one of greater than, smaller than and equal to a strength of said second signal transmitted from said master control member.

18. A method for locating an object, said method comprising the steps of:
(a) providing a master control member capable of transmitting a first signal, receiving a second signal and emitting a first externally detectable annunciation signal responsive to receipt of said second signal;
(b) providing a slave member engageable with such object and capable of receiving said first signal, transmitting said second signal in response to receipt of said first signal and emitting a second externally detectable annunciation signal responsive to receipt of said first signal;
(c) activating said master control member to transmit said first signal to said slave member;
(d) receiving said first signal at said slave member when said slave member is disposed within a predetermined distance range;
(e) transmitting said second signal to said master control member in response to receipt of said first signal;
(f) emitting said second externally detectable annunciation signal in response to receipt of said second signal;
(g) emitting said first externally detectable annunciation signal in response to receipt of said second signal; and
(h) locating such object by detecting said second annunciation signal emitted from said slave member.

19. A method for locating an object, said method comprising the steps of:
(a) providing a master control member capable of receiving a first signal, transmitting a second signal and emitting an externally detectable first annunciation signal responsive to receipt of said first signal;
(b) providing a slave member engageable with such object and capable of transmitting said first signal, receiving said second signal and emitting an externally detectable second annunciation signal responsive to receipt of said second signal;
(c) intermittently activating said slave member to transmit said first signal to said master control member;
(d) receiving said first signal at said master control member when said slave member is disposed within a predetermined distance range;
(e) emitting said first externally detectable annunciation signal responsive to receipt of said first signal and indicating presence of such object within said predetermined distance range;
(f) transmitting said second signal to said slave member;
(g) emitting said second externally detectable annunciation signal responsive to receipt of said second signal; and
(h) locating such object by detecting said second annunciation signal emitted from said slave member.

20. A system for locating an object, said system comprising:
(a) a master control member including:
(i) a master housing having each of a predetermined shape and a predetermined size,
(ii) means disposed within said master housing for receiving a first signal,
(iii) means disposed within said master housing for emitting a first annunciation signal in response to receipt of said first signal,
(iv) means disposed within said master housing for transmitting a second signal, and
(v) a master power source disposed within said master housing; and
(b) a slave member attached to such object, said slave member including:
(i) a slave housing having each of a predetermined shape and a predetermined size,
(ii) means engageable with said slave housing for one of removably and rigidly attaching it to a predetermined portion of such object,
(iii) means disposed within said slave housing for transmitting said first signal at a predetermined time interval,
(iv) means disposed within said slave housing for receiving said second signal,
(v) means disposed within said slave housing for emitting a second annunciation signal in response to receipt of said first signal, and
a slave power source disposed within said slave housing.
